(19) United States
(12) Patent Application Publication
(10) Pub. No.: US 2024/0370781 A1
(43) Pub. Date: Nov. 7, 2024

(54) CONFIGURATION OF COMPUTE RESOURCES TO PERFORM TASK USING ENSEMBLE

(71) Applicant: Microsoft Technology Licensing, LLC, Redmond, WA (US)

(72) Inventors: Anand PADMANABHA IYER, Redmond, WA (US); Jayashree MOHAN, Bengaluru (IN); Ranjita BHAGWAN, Bangalore (IN); Nagarajan NATARAJAN, Bangalore (IN); Venkata N. PADMANABHAN, Bengaluru (IN); Rohit MALLIKARJUNA PUSHPA, Bangalore (IN); Divyam ANSHUMAAN, New Delhi (IN)

(21) Appl. No.: 18/332,589

(22) Filed: Jun. 9, 2023

(30) Foreign Application Priority Data
May 2, 2023 (IN) 202311031350

(51) Int. Cl. G06N 20/20

(52) U.S. Cl. CPC G06N 20/20

(57) ABSTRACT

Computer-assisted configuration of compute resource to perform tasks of a given inference task type. For each of multiple model combinations, the computing system estimates 1) a compute level that can perform tasks of the given inference type using the model combination, and 2) an accuracy of the model combination in performing tasks of the given inference task type. The computing system then selects a model combination for the given inference task type based on the estimated compute level of the model combination and the estimated accuracy of the model combination. In response to the selection, an inference component is configured to respond to task requests of the given inference task type by using the selected model combination. Scheduling using batch size and input size may further improve accuracy and efficiency of the model combination.

### CROSS-REFERENCE TO RELATED APPLICATIONS

This application claims the benefit of and priority to Indian patent application No. 202311031350 filed on May 2, 2023, and entitled “CONFIGURATION OF COMPUTE RESOURCES TO PERFORM TASK USING ENSEMBLE,” which application is expressly incorporated herein by reference in its entirety.

### BACKGROUND

Artificial Intelligence (AI) is the use of computing models to perform tasks. Such tasks can be performed in response to the application of rules to data. However, one type of artificial intelligence is machine learning, in which the computing model learns how to do tasks based on encountering data. The performance of such a task is often termed as “inference” in machine learning vernacular.

Deep neural networks are one example of a type of machine learning model. Deep neural networks are becoming more and more complex in an effort to improve upon accuracy of inferences performed by the machine learning model. Complex deep neural networks excel in a number of areas including, for example, computer vision and natural language processing. However, the complexity of such deep neural networks can be enormous with some deep neural networks having on the order of hundreds of billions of parameters. Future deep neural networks are anticipated to be even more complex. While the complexity of a deep neural network model does tend to improve accuracy of the inference that the model is trained to do, the model can take a significant amount of time and resources to generate an inference. It can thus be more difficult to use such models on a steady stream of requests. For instance, many model services may encounter billions or even trillions of inference requests per day.

One conventional technique to reduce the resources and time required to handle large volumes of inference requests is to replace the large model with a single, smaller variant, typically obtained using conventional techniques including distillation, quantization, and sparcification. However, replacing the larger model with a smaller model often comes with a reduction in the inference accuracy.

Another conventional technique is referred to as “ensembling”. In ensembling, a collection of smaller models of varying accuracies and inference latencies are used to perform the same inference task. The inference results from each of the ensemble models are then aggregated (e.g., through majority-voting or averaging) to produce the final inference result.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments described herein relate to the computer-assisted configuration of compute resources to perform tasks of a given inference task type using a machine-learning model combination. The computing system has access to a model set, and evaluates various combinations of such models for how they would perform when executing tasks of a task type. The evaluation takes into account a balance between the accuracy of the model combination, the compute resources that are estimated to be used by the model combination, and the expected latency of the model combination in responding to task requests. Hereinafter, a model combination being evaluated may also be referred to as an “ensemble”, and the models that form the ensemble may also be referred to herein as “constituent models” of the ensemble.

The computing systems evaluates various ensembles that may be assembled from the model set. For each of multiple ensembles, the computing system estimates 1) a compute level that can perform tasks of the given inference type using the ensemble, and 2) an accuracy of the ensemble in performing tasks of the given task type. The computing system then selects an ensemble for the given task type based on at least one of 1) the estimated compute level of the ensemble and 2) the estimated accuracy of the ensemble. In response to the selection, an inference component is configured to respond to task requests of the given task type by using the selected ensemble.

The compute level is a function of both the compute resources on which the ensemble is to run as well as an expected time that the compute resources will take to respond to a task request of the given task type. Accordingly, the selection of the selected ensemble takes into account a balance between the accuracy of the ensemble, the compute resources that are used by the ensemble, and the expected latency of the ensemble in responding to task requests. In some embodiments, the expected latency is bound to be below a certain time limit, meaning that the compute level is a function of the computing power consumed to allow the ensemble to generate a response within the time limit.

In some embodiments, a maximum number of constituent models for each ensemble is restricted to be at or below a maximum number. Alternatively, or in addition, evaluated aggregation methods used to aggregate results from the consistent models into a final result for the corresponding ensemble are also constrained to be only one of a small set of possible aggregation methods. These constraints reduce the search space when evaluating the ensembles for the given inference task type.

In some embodiments, accuracy and/or latency is further improved by selecting batch sizes that are to be handled by each model by accumulating batch requests, and submitting the batch of task requests to the respective model upon reaching a particular batch size or upon determining that expected latency is at risk if further accumulation is continued. In some embodiments, accuracy and/or latency is further improved by ordering the batch requests according to groupings of input size.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates a model profiling environment in which each of multiple models of a model set are profiled to generate performance data that is specific to the model and task type;

FIG. 2 illustrates performance data that includes a compute level and accuracy as well as identifying information include model identifier, task type identifier, and aggregation method identifier;

FIG. 3 illustrates an ensemble profiling environment in accordance with the principles described herein, in which ensemble performance data is generated from the performance data of constituent models;

FIG. 4 illustrates a graph that plots (with respect to a reference model), a compute level reduction on the horizontal axis, and relative accuracy on the vertical axis;

FIG. 5 illustrates a flowchart of a method for selecting an ensemble to use when performing tasks of a particular task type, in accordance with the principles described herein;

FIG. 6 illustrates a deployment environment in which a selected ensemble is deployed onto an inference component;

FIG. 7 illustrates a plot the latency (ms) and throughput (img/s) for different batch sizes;

FIG. 8 shows an example of input processing in a situation in a particular example for a case in which input-aware scheduling is not performed (on the left), and for a case in which input-aware scheduling is performed (on the right); and

FIG. 9 illustrates a basic configuration of a computing system in which the principles described herein may be practiced.

### DETAILED DESCRIPTION

Embodiments described herein relate to the computer-assisted configuration of compute resources to perform tasks of a given inference task type using a machine-learning model combination. The computing system has access to a model set, and evaluates various combinations of such models for how they would perform when executing tasks of a task type. The evaluation takes into account a balance between the accuracy of the model combination, the compute resources that are estimated to be used by the model combination, and the expected latency of the model combination in responding to task requests. Hereinafter, a model combination being evaluated may also be referred to as an “ensemble”, and the models that form the ensemble may also be referred to herein as “constituent models” of the ensemble.

The computing systems evaluates various ensembles that may be assembled from the model set. For each of multiple ensembles, the computing system estimates 1) a compute level that can perform tasks of the given inference type using the ensemble, and 2) an accuracy of the ensemble in performing tasks of the given task type. The computing system then selects an ensemble for the given task type based on at least one of 1) the estimated compute level of the ensemble and 2) the estimated accuracy of the ensemble. In response to the selection, an inference component is configured to respond to task requests of the given task type by using the selected ensemble.

The compute level is a function of both the compute resources on which the ensemble is to run as well as an expected time that the compute resources will take to respond to a task request of the given task type. Accordingly, the selection of the selected ensemble takes into account a balance between the accuracy of the ensemble, the compute resources that are used by the ensemble, and the expected latency of the ensemble in responding to task requests. In some embodiments, the expected latency is bound to be below a certain time limit, meaning that the compute level is a function of the computing power consumed to allow the ensemble to generate a response within the time limit.

In some embodiments, a maximum number of constituent models for each ensemble is restricted to be at or below a maximum number. Alternatively, or in addition, evaluated aggregation methods used to aggregate results from the consistent models into a final result for the corresponding ensemble are also constrained to be only one of a small set of possible aggregation methods. These constraints reduce the search space when evaluating the ensembles for the given task type.

In some embodiments, accuracy and/or latency is further improved by selecting batch sizes that are to be handled by each model by accumulating batch requests, and submitting the batch of task requests to the respective model upon reaching a particular batch size or upon determining that expected latency is at risk if further accumulation is continued. In some embodiments, accuracy and/or latency is further improved by ordering the batch requests according to groupings of input size.

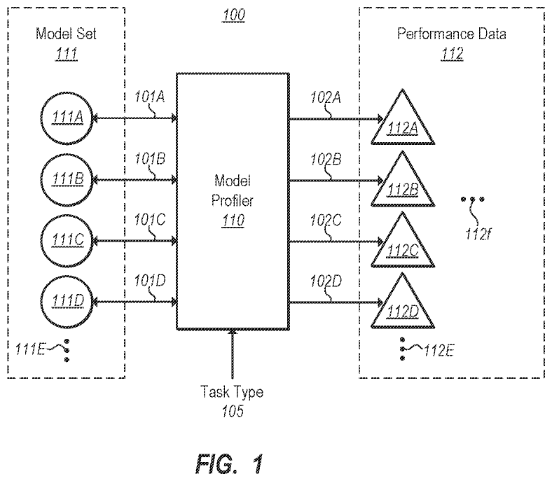

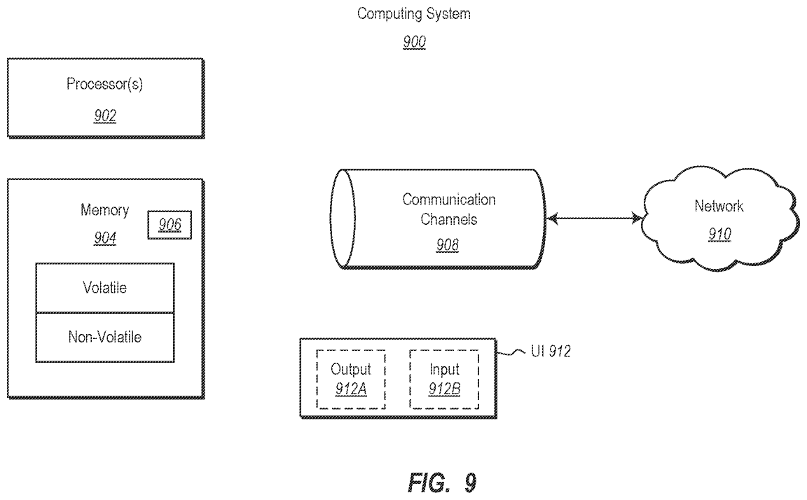

FIG. 1 illustrates a model profiling environment 100 in which each of multiple models of a model set are profiled to generate performance data that is specific to the model and task type. The profiling of models may be performed in preparation for selecting appropriate ensembles of such models based on the performance data for each model. The model profiling environment 100 includes a model profiler 110 that generates performance data 112 for the model set 111. As an example, if the model profiling environment 100 is performed in the context of a computing system such as the computing system 900 described below with respect to FIG. 9, the model profiler 110 may be structured as described below for the executable component 906. In FIG. 1, models of the model set 111 are represented as circles, and corresponding performance data of those models are represented as triangles.

The model profiler 110 has access to a model set 111 of multiple models. The model set 111 includes models that may potentially be combined as constituent models to form an ensemble that may perform a task. In the illustrated embodiment, the model set 111 includes four models 111A, 111B, 111C and 111D. However, the ellipsis 111E represents that the model set 111 may include any number of models. The accessing of the model profiler 110 to each of the models 111A, 111B, 111C and 111D is represented by respective bi-directional arrows 101A, 101B, 101C and 101D. The models may be any machine-learning model such as, but not limited to, a decision tree, a neural network, or a combination thereof.

The model profiler 110 also receives a task type 105 that represents an inference task that the model profiler 110 is to generate performance data about. Examples of task types may include a vision task, or a language task. That is, the model profiler 110 will generate expected performance data for each model in performing the task of the task type 105. As an example, as represented by the arrow 102A, the model profiler 110 generates performance data 112A that represents performance data of the model 101A in performing tasks of the task type 105. Likewise, as represented by respective arrows 102B, 102C and 102D, the model profiler 110 generates respective performance data 112B, 112C and 112D that represents performance data of respective models 111B, 111C and 111D in performing tasks of the task type. The vertical ellipsis 112E represents that the model profiler 110 may similarly generate performance data for as yet other models in connection with performing tasks of the task type 105. The vertical ellipsis 112E also represents that the model profiler 110 may generate performance data for as yet other models as those other models are added to the model set 111.

The horizontal ellipsis 112F represents that the model profiler 110 may generate performance data for each model also for other types of tasks as well. For example, the model profiler 110 might generate one set of performance data for the model 111A when performing a vision task, and another set of performance data for the same model 111A when performing a language task. Thus, the model profiler 110 may generate performance data for each of multiple models and for each of multiple task types.

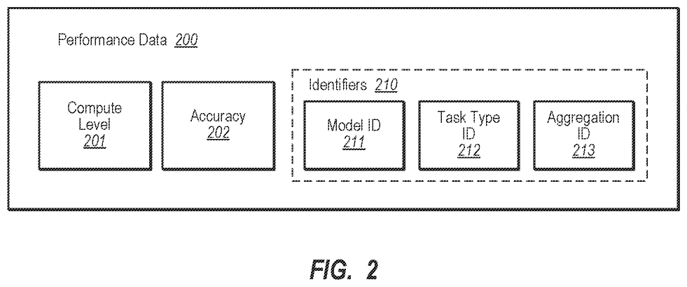

As an example, FIG. 2 illustrates performance data 200 that includes performance data in the form of a compute level 201 and an accuracy 202. The compute level 201 represents a compute level that may be used to perform tasks of the given task type using the model. The compute level 201 may, for example, be an expression of time that is sufficient for a given compute power to perform tasks of the given task type, or perhaps may be a compute power that is sufficient to perform tasks of the given task type within a given time. That given time might be, for example, an acceptable time period for performing the inference task from the time that a request to perform the task is received until the time that the model completes the task. As an example, the acceptable time period may be a response latency defined by an application that is to use an ensemble that will be selected.

The accuracy 202 of the model may be estimated by comparing the output of a model that has received test data against a ground truth (e.g., in the form of a label) associated with that test data. However, alternatively, when such ground truth is not associated with the test data, the test data may be partitioned for example into two randomly seeded splits. The labels may be taken as the model results resulting from the first split, whereas accuracy is measured by taking the model results resulting from the second split, and comparing against model results resulting from the first split.

The performance data 200 may also include identifying information 210, including a model identifier 211 and a task type identifier 212. Thus, the performance data 200 includes the estimated compute level and accuracy when the model identified by the model identifier 211 performs tasks of the type identified by the task type identifier 212. Thus, there may be an instance of the performance data for each model and for each task type.

In addition to specifying performance data by model identifier and task type identifier, the performance data may also be specified by aggregation type. Accordingly, the performance data 200 may also have an aggregation type identifier 213. Aggregation is a method used to combine results from each of the constituent models of an ensemble to generate a final result. The most common types of aggregation are majority wins and weighted averaging. In accordance with some embodiments described herein, performance data for only a limited number of aggregation methods are kept, such as for example only for majority wins and weighted averaging aggregation methods. Accordingly, there may be performance data for each model, task type, and aggregation method where the number of aggregation methods is kept small.

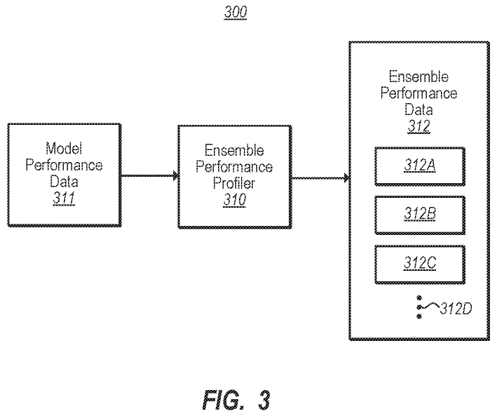

FIG. 3 illustrates an ensemble profiling environment 300 in accordance with the principles described herein. The model profiling environment 100 of FIG. 1 generates model-specific performance data regarding estimated performance of the models of the model set 111. However, the ensemble profiling environment 300 uses model performance data 311 to generate ensemble performance data 312. In one example, the model performance data 311 is the same model performance data 112 that was generated by the model profiler 110 of FIG. 1. In that example, the performance data 312 may include ensemble performance data for each of multiple ensembles that may be constructed using constituent models selected from the model set 111. As an example, if the ensemble profiling environment 100 is performed in the context of a computing system such as the computing system 900 described below with respect to FIG. 9, the ensemble performance profiler 310 may be structured as described below for the executable component 906. In the illustrated case, the ensemble performance profiler 310 generates ensemble performance data 312A, 312B and 312C for three different ensembles. However, the ellipsis 312D represents that the ensemble performance profile 310 may generate performance data for any number of ensembles.

In one embodiment, the performance data for each ensemble and for each given task type may also includes an estimated compute level that would be used by the ensemble to accomplish tasks of the task type, as well as estimated accuracy of the ensemble in performing tasks of the task type. These estimations may be accomplished via the use of the estimated compute levels and accuracies for the constituent models. A specific example will now be provided.

As an example, suppose that an ensemble of three models is being evaluated. The models will be referred to as model A, model B, and model C, whereas the model ensemble will be referred to as ensemble ABC. Suppose also that a compute level may be estimated in terms of a measure referred to herein as “compute units”, which may be any unit of processing. Now suppose that ensemble ABC is being evaluated against a given task type, and that for that given task type, model A is estimated to consume 5 compute units to generate a result that is estimated to be 90 percent accurate, model B is estimated to consume 4 compute units to generate a result that is also 90 percent accurate, and that model C is estimated to consume 3 compute units to generate a result that is also 90 percent accurate. The total number of compute units for ensemble ABC to perform the task is the sum of the compute units that it would take for the individual models, plus some amount of compute used to aggregate. Suppose then that the compute units estimated to be consumed by the ensemble ABC would then be 12 compute units (5+4+3), and that the accuracy would be approximately 97.2 percent (=(9/10)\hat{ }3+3*(1/10)*(9/10)\hat{ }2≈0.972) assuming that the accuracy of each result from each model is not correlated.

A key point here as that the compute level and the accuracy of a given ensemble of models and aggregation method may be determined based on the compute level and the accuracy of each of the constituent models. Thus, the ensemble performance data 312 may be generated from the model performance data 311 rather from actually running the corresponding ensemble.

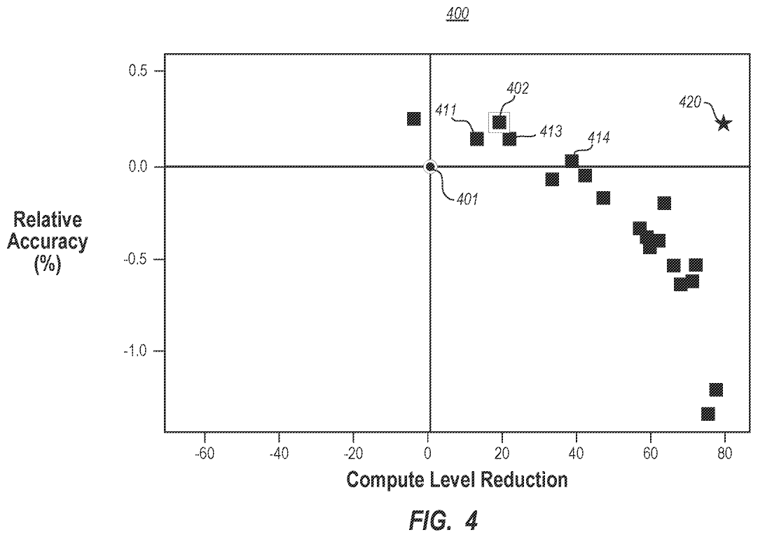

FIG. 4 illustrates a graph 400 that plots (with respect to a reference model), a compute level reduction on the horizontal axis, and relative accuracy on the vertical axis. The reference model may, for example, be a single larger model that can perform tasks of a given task type, but for which an ensemble of models are being searched for that can replace the reference model. Since compute level reduction and relative accuracy is plotted with respect to the reference model, the performance of the reference model is represented by the reference circle 401 at the origin where the two axes intersect at their zero point.

On the other hand, each square represents a performance point of a corresponding evaluated ensemble. The estimated relative performance improvement of each evaluated ensemble may then be compared against the performance of the reference model. In this experiment, an ensemble was limited to have no more than three constituent models. Thus, almost all of the ensembles were estimated to use less compute levels than the larger model (meaning that there was a positive compute level reduction). However, most ensembles were estimated to have less accuracy than the larger reference model.

Notwithstanding, there were a few ensembles with performance points (see points 411, 412, 413 and 414) that were estimated to have a lower compute level with a higher accuracy than the larger reference model. The ensembles associated with one of these improved performance points 411, 412, 413 or 414 may then be selected as the ensemble to use when performing tasks of the given task type. For instance, in FIG. 4, perhaps the ensemble associated with the performance point 412 may be selected as the ensemble to perform tasks of the associated task type.

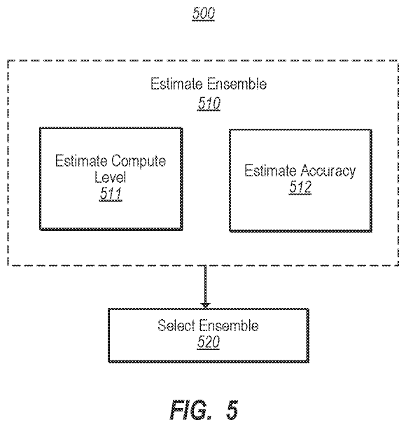

This performance point 412 may be selected because it provides the most accuracy improvement over the reference model. However, as will be explained further below after the description of FIG. 5, that same accuracy improvement may be obtained at even further reduced cost using some refinements in batching size requests and reordering requests according to input size. For instance, the point represented by the star 420 may be potentially achieved using the same ensemble that is estimated to have performance at performance point 412, but with the refinements described below.

FIG. 5 illustrates a flowchart of a method 500 for selecting an ensemble to use when performing tasks of a particular task type, in accordance with the principles described herein. The method 500 includes an act of evaluating an ensemble (act 510) for performance of a task type. This ensemble evaluation (act 510) is represented by the acts within the dashed-lined box, and may be repeated for multiple possible ensembles. The evaluated ensembles may have constituent models taken from the model set 111 of FIG. 1. The evaluation of the ensembles may be performed without actually executing the ensembles, but rather by using performance data of the associated constituent models.

The number of ensembles evaluated may be kept manageable by restricting the maximum number of constituent models that an ensemble may have. For example, if the number of models in the model set 111 is thirty (30), then the number of possible unique ensembles of multiple constituent models would be over one billion. However, by restricting the number of constituent models to only 4 or less, the number may be significantly reduced to 31,900 (there would be 435 unique ensembles having 2 constituent models, 4,060 unique ensembles having 3 constituent models, and 27,405 unique ensembles having 4 constituent models). However, by restricting the number of constituent models to only 3 or less, the number may be reduced further to only 4,495 unique ensembles (where there would be 435 unique ensembles having 2 constituent models, and 4,060 unique ensembles having 3 constituent models). If there is performance data for each of the 4,495 ensembles for each of two aggregation methods (majority wins and averaging), then the set of performance data may still be below 10,000.

The ensemble evaluation (act 510) includes estimating a compute level that can perform tasks of the given task type using the ensemble (act 511). The ensemble evaluation also includes estimating an accuracy of the model combination in performing tasks of the given task type (act 512). As an example, each ensemble evaluation (act 510) may result in a corresponding performance point plotted on the graph 400 of FIG. 4. By performing ensemble evaluation with respect to many different ensembles, a robust collection of performance data may be achieved across multiple evaluated ensembles, like the performance data of the graph 400 of FIG. 4.

Referring again to FIG. 5, the method includes selecting a model combination for the given inference task type (act 520). This selection uses as inputs the estimated compute level of the ensemble and the estimated accuracy of the ensemble. For example, in FIG. 4, the ensemble having the performance point 412 may be selected based on increased accuracy as compared to the reference model.

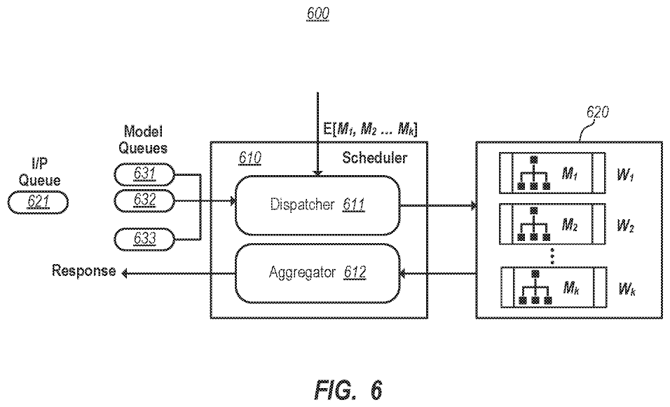

Once the ensemble is selected for a given task type, the ensemble may be deployed on a computing system that is actually going to perform tasks of the task type. FIG. 6 illustrates a deployment environment 600 in which a selected ensemble is deployed onto an inference component 610. The inference component 610 receives (as represented by arrow 601) ensemble information including an identification of the constituent models of the ensemble as well as the aggregation method to be used. In this case, the ensemble is shown as including constituent models M₁, M₂ . . . M_{K}.

The inference component 610 then sets up an execution environment 620 that includes a worker W₁, W₂ . . . W_{K} on which each model may be run. As an example, a worker might be a graphics processing unit. Nonetheless, the worker has sufficient compute power such that the respective model can perform tasks of the task type within a given latency. Thus, inference component 610 may also select the compute resources that would perform the compute level within the given latency for the given rate of task requests of the given inference task type. The inference component 610 also sets the aggregator 612 up to perform aggregation using the selected aggregation method identified in the received ensemble information 601. In one embodiment, a dispatcher thread is spawned for each model queue.

As tasks requests come in, they are enqueued into the I/P queue 621 after which they are duplicated and placed within each model queue 631, 632, 633. Each constituent model has a corresponding model queue. The dispatcher 611 performs scheduling of the task requests in each model queue, and submits the task request to the appropriate model at the appropriate scheduled time. The aggregator 612 receives the results of the task execution by each constituent model and aggregates according to the selected aggregation method. The I/P queue 621 may receive a steady stream of task requests of the task type, and the inference component 610 may provide a steady stream of task results within a designated latency.

Inference is typically done in batches of multiple task requests at a time. In some embodiments, the dispatcher 611 performs compute-aware batching. The dispatcher 611 tracks the arrival time of each request and initiates batch formation. The dispatcher 611 may wait for a short duration to allow larger batches to be formed, for better throughput. A common practice in inference serving systems is to use a large enough batch size whose latency is just within the latency SLO. This is termed “dynamic batching”.

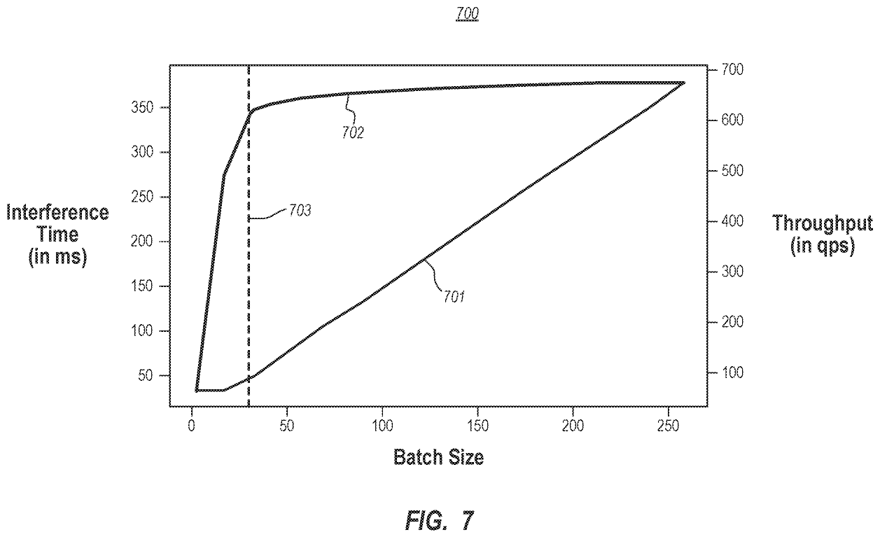

However, the inventors make an observation that it is ineffectual to increase batch size beyond the point where throughput and inference latency starts linearly scaling. FIG. 7 illustrates a plot 700 of the latency (ms) and throughput (img/s) for different batch sizes where the task type is image classification. Batch sizes are plotted on the horizontal axis. The curve 701 represents inference time where the vertical axis represents time in milliseconds. The curve 702 represents throughput (in tasks processed per second) on the vertical axis. The plot 700 is an actual experimental result for a task type of image classification. The plot 700 shows that throughput has diminishing returns beyond batch size 32 (see line 703) as higher batch sizes saturates the worker (in this case a graphics processing unit), or cannot exploit parallelism further due to model implementation. Beyond this point, the corresponding batch latency scales almost linearly. This model latency profile may be used to identify a compute-appropriate batch size. The batch size estimation may, for example, pick a threshold on throughput tradeoff (e.g., 5%), and identify the compute-appropriate optimal batch size as the one beyond which the marginal increase in throughput is under the chosen threshold. Thus, the dispatcher 611 may automatically tune the compute-appropriate batch size so as to reduce response latency.

There is an added dimension of complexity in picking a compute-appropriate batch size for models with varying input lengths. Many transformer-based language accept variable sized input sequences. When processing larger batches of inputs, the tensor computations often require all requests in a batch to be of identical length. To address this, dynamic padding is often performed by padding the inputs to the length of the largest input in a batch. The final encoding of tokens in a sequence is not affected by the padding tokens. The batch latency is directly proportional to the length of the input sequence in a batch, and therefore any computation over these padding tokens in a batch is wasted.

To minimize wasted computation and reduce latency, the dispatcher 611 may perform input-aware scheduling. This exploits the distribution of query lengths and groups the queries such that the difference in sequence lengths of requests in a batch is smaller. This may be achieved by splitting the model queues into multiple discrete sections, and enqueuing requests into appropriate sections based on the input size. Requests are batched within each section, thereby reducing the amount of wasteful padding in a batch. For each section, the inference component 610 identifies the optimal compute-appropriate batch size as described above, so as to efficiently utilize hardware in each section. This improves inference throughput.

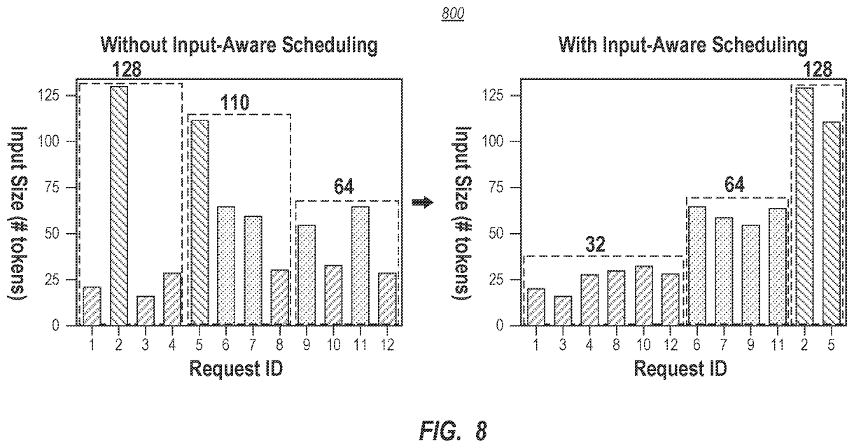

FIG. 8 shows an example of input processing a particular example for a case in which input-aware scheduling is not performed (on the left), and for a case in which input-aware scheduling is performed (on the right). Consider a set of requests of varying sizes, as shown in FIG. 8, being served without input-size batching with an SLO of 15 ms. Without the scheduling optimizations described herein, the batches are formed in the order in which the requests arrived. Two of the batches formed require input lengths to be padded to 128 and 110, and therefore take around 20 ms to be processed, violating the SLA, and the third, requiring padding up to length 64, takes 12 ms. The average response time across all requests is 17.3 ms ((20×4+20×4+12×4)/12=17.3). However, when input-aware scheduling and appropriate batch size selection is enabled, the padding is minimized and all requests are served within 12 ms, well within the SLA, with an average response time of 11 ms ((10×6+12×4+12×2)/12=11).

In this example, the dispatcher 611 may accumulate task requests, and while accumulating requests determine whether the accumulated task request has reached the determined batch size, and determine whether further accumulation of task requests would increase latency of any task request at risk of exceeding the given latency. If it is determined either that the accumulated task requests has reached the determined batch size, or that further accumulation of task requests would increase the latency of any task request at risk of exceeding the given latency, the dispatcher submits the accumulate task requests to the ensemble.

As the various environments described above may be accomplished via a computing system, an example computing system will now be described with respect to FIG. 9. As illustrated in FIG. 9, in its most basic configuration, a computing system 900 includes at least one hardware processing unit 902 and memory 904. The processing unit 902 includes a general-purpose processor. Although not required, the processing unit 902 may also include a field programmable gate array (FPGA), an application specific integrated circuit (ASIC), or any other specialized circuit. In one embodiment, the memory 904 includes a physical system memory. That physical system memory may be volatile, non-volatile, or some combination of the two. In a second embodiment, the memory is non-volatile mass storage such as physical storage media. If the computing system is distributed, the processing, memory and/or storage capability may be distributed as well.

The computing system 900 also has thereon multiple structures often referred to as an “executable component”. For instance, the memory 904 of the computing system 900 is illustrated as including executable component 906. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods (and so forth) that may be executed on the computing system. Such an executable component exists in the heap of a computing system, in computer-readable storage media, or a combination.

One of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard-coded or hard-wired logic gates. The computer-executable instructions (and the manipulated data) may be stored in the memory 904 of the computing system 900. Computing system 900 may also contain communication channels 908 that allow the computing system 900 to communicate with other computing systems over, for example, network 910.

While not all computing systems require a user interface, in some embodiments, the computing system 900 includes a user interface system 912 for use in interfacing with a user. The user interface system 912 may include output mechanisms 912A as well as input mechanisms 912B. The principles described herein are not limited to the precise output mechanisms 912A or input mechanisms 912B as such will depend on the nature of the device. However, output mechanisms 912A might include, for instance, speakers, displays, tactile output, virtual or augmented reality, holograms and so forth. Examples of input mechanisms 912B might include, for instance, microphones, touchscreens, virtual or augmented reality, holograms, cameras, keyboards, mouse or other pointer input, sensors of any type, and so forth.

Embodiments described herein may comprise or utilize a special-purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then be eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special-purpose computing system, or special-purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable compute resources (e.g., networks, servers, storage, applications, and services). The definition of “cloud computing” is not limited to any of the other numerous advantages that can be obtained from such a model when properly deployed.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

Clause 1. A computing system comprising: one or more processors; and one or more computer-readable media having thereon computer-executable instructions that are structured such, when executed by the one or more processors, the computing system would be adapted to: for a given inference task type, for each of a plurality of machine-learning model combinations, estimating 1) a compute level that is structured to perform tasks of the given inference type using the machine-learning model combination, the machine-learning modes of the given inference task type each able to perform a task result of a particular type, and 2) an accuracy of the machine-learning model combination in performing tasks of the given inference task type, the accuracy obtained by comparing against a ground truth or a result of a randomly seeded split; selecting a machine-learning model combination for the given inference task type according to at least one of 1) the estimated compute level of the model combination and 2) the estimated accuracy of the model combination; and in response to the selection, configuring an inference component to respond to a task request of the given inference task type by using the selected model combination such that the inference components responds to task requests of the given inference type using the selected model combination.

Clause 2. The computing system in accordance with Clause 1, the computer-executable instructions being structured such that, when executed by the one or more processors, the computing system would be adapted to configure the inference component with compute resources to perform the compute level within a given latency for a given rate of task requests of the given inference task type.

Clause 3. The computing system in accordance with Clause 2, the computer-executable instructions being structured such that, when executed by the one or more processors, the computing system would be adapted to select the compute resources that would perform the compute level within the given latency for the given rate of task requests of the given inference task type.

Clause 4. The computing system in accordance with Clause 2, the computer-executable instructions being structured such that, when executed by the one or more processors, the computing system would be adapted to: determine a batch size of the task requests based on the compute resources.

Clause 5. The computing system in accordance with Clause 4, the computer-executable instructions being structured such that, when executed by the one or more processors, the computing system would be adapted to select the compute resources that would perform the compute level within the given latency for the given rate of task requests of the given inference task type and with a given ability of the compute resources to handle batching.

Clause 6. The computing system in accordance with Clause 4, the computer-executable instructions being structured such that, when executed by the one or more processors, the computing system would be adapted to: respond to receiving a plurality of task requests to perform tasks of the given inference type by scheduling the plurality of task requests with each machine-learning model of the selected machine-learning model combination.

Clause 7. The computing system in accordance with Clause 6, the computer-executable instructions being structured such that, when executed by the one or more processors, the computing system would be adapted to perform scheduling by: accumulating task requests, and while accumulating requests determining whether the accumulated task request has reached the determined batch size, and determining whether further accumulation of task requests would increase latency of any task request at risk of exceeding the given latency.

Clause 8. The computing system in accordance with Clause 7, the computer-executable instructions being structured such that, when executed by the one or more processors, the computing system would be adapted to perform scheduling by: if determining either that the accumulated task requests has reached the determined batch size, or that further accumulation of task requests would increase latency of any task request at risk of exceeding the given latency, submitting the accumulate task requests to the model combination.

Clause 9. The computing system in accordance with Clause 8, the computer-executable instructions being structured such that, when executed by the one or more processors, the computing system would be adapted to perform scheduling by: reordering the task requests to group according to groups based on input size.

Clause 10. The computing system in accordance with Clause 1, the computer-executable instructions being structured such that, when executed by the one or more processors, the computing system would be adapted to: reordering the task requests to group according to groups based on input size.

Clause 11. The computing system in accordance with Clause 1, the compute level being expressed as a time that is sufficient for a given compute power to perform tasks of the given inference type.

Clause 12. The computing system in accordance with Clause 1, the compute level being expressed as a compute power that is sufficient to perform tasks of the given inference type within a given time.

Clause 13. The computing system in accordance with Clause 1, the plurality of combinations being restricted to be a maximum number of machine-learning models.

Clause 14. The computing system in accordance with Clause 13, the maximum number of machine-learning models being four.

Clause 15. The computing system in accordance with Clause 13, the maximum number of machine-learning models being three.

Clause 16. The computing system in accordance with Clause 1, the computer-executable instructions being structured such that, when executed by the one or more processors, the computing system would be adapted to do the following for each at least some of the plurality of machine-learning model combinations: for each of a plurality of aggregation methods for the machine-learning model combination, estimate an accuracy of the machine-learning model combination in performing tasks of the given inference task type with the aggregation method, the selection of the machine-learning model combination for the given inference task type also selecting the aggregation method for the machine-learning model combination.

Clause 17. The computing system in accordance with Clause 1, the accuracy of the machine-learning model combination in performing tasks of the given inference task type comprising splitting input data into a first subset of input data and a second set of input data, the accuracy of the model combination being measured by a conformity between the output of the model combination when provided with the first subset of the input data and the output of the machine-learning model combination when provided with the second subject of the input data.

Clause 18. A method for configuring compute resources to perform tasks of a given inference task type by: for each of a plurality of machine-learning model combinations, estimating 1) a compute level that is structured to perform tasks of the given inference type using the machine-learning model combination, and 2) an accuracy of the machine-learning model combination in performing tasks of the given inference task type, the accuracy obtained by comparing against a ground truth or a result of a randomly seeded split; selecting a machine-learning model combination for the given inference task type according to at least one of 1) the estimated compute level of the model combination and 2) the estimated accuracy of the model combination; and in response to the selection, configuring an inference component to respond to task requests of the given inference task type by using the selected model combination such that the inference components responds to task requests of the given inference type using the selected model combination.

Clause 19. The method in accordance Clause 18, further comprising: responding to receiving a plurality of task requests to perform tasks of the given inference type by scheduling the plurality of task requests with each machine-learning model of the selected machine-learning model combination, the scheduling being performed by: accumulating task requests, and while accumulating requests determining whether the accumulated task requests have reached the determined batch size, and determining whether further accumulation of task requests would increase latency of any task request at risk of exceeding the given latency; and if determining either that the accumulated task requests has reached the determined batch size, or that further accumulation of task requests would increase latency of any task request at risk of exceeding the given latency, submitting the accumulate task requests to the model combination.

Clause 20. A computer program product comprising one or more computer-readable storage media having stored thereon computer-executable instructions that are structured such that, when executed by one or more processors of a computing system, the computing system would be configured to perform a method for configuring compute resources to perform tasks of a given inference task type by: for each of a plurality of machine-learning model combinations, estimating 1) a compute level that can perform tasks of the given inference type using the machine-learning model combination, and 2) an accuracy of the machine-learning model combination in performing tasks of the given inference task type, the accuracy obtained by comparing against a ground truth or a result of a randomly seeded split; selecting a machine-learning model combination for the given inference task type according to the estimated compute level of the model combination and the estimated accuracy of the model combination; and in response to the selection, configuring an inference component to respond to task requests of the given inference task type by using the selected model combination such that the inference components responds to task requests of the given inference type using the selected model combination.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

What is claimed is:

1. A computing system comprising:
one or more processors; and
one or more computer-readable media having thereon computer-executable instructions that are structured such, when executed by the one or more processors, the computing system would be adapted to:
for a given inference task type, for each of a plurality of machine-learning model combinations, estimating 1) a compute level that is structured to perform tasks of the given inference type using the machine-learning model combination, the machine-learning modes of the given inference task type each able to perform a task result of a particular type, and 2) an accuracy of the machine-learning model combination in performing tasks of the given inference task type, the accuracy obtained by comparing against a ground truth or a result of a randomly seeded split;
selecting a machine-learning model combination for the given inference task type according to at least one of 1) the estimated compute level of the model combination and 2) the estimated accuracy of the model combination; and
in response to the selection, configuring an inference component to respond to a task request of the given inference task type by using the selected model combination such that the inference components responds to task requests of the given inference type using the selected model combination.

2. The computing system in accordance with claim 1, the computer-executable instructions being structured such that, when executed by the one or more processors, the computing system would be adapted to configure the inference component with compute resources to perform the compute level within a given latency for a given rate of task requests of the given inference task type.

3. The computing system in accordance with claim 2, the computer-executable instructions being structured such that, when executed by the one or more processors, the computing system would be adapted to select the compute resources that would perform the compute level within the given latency for the given rate of task requests of the given inference task type.

4. The computing system in accordance with claim 2, the computer-executable instructions being structured such that, when executed by the one or more processors, the computing system would be adapted to:
determine a batch size of the task requests based on the compute resources.

5. The computing system in accordance with claim 4, the computer-executable instructions being structured such that, when executed by the one or more processors, the computing system would be adapted to select the compute resources that would perform the compute level within the given latency for the given rate of task requests of the given inference task type and with a given ability of the compute resources to handle batching.

6. The computing system in accordance with claim 4, the computer-executable instructions being structured such that, when executed by the one or more processors, the computing system would be adapted to:
respond to receiving a plurality of task requests to perform tasks of the given inference type by scheduling the plurality of task requests with each machine-learning model of the selected machine-learning model combination.

7. The computing system in accordance with claim 6, the computer-executable instructions being structured such that, when executed by the one or more processors, the computing system would be adapted to perform scheduling by:
accumulating task requests, and while accumulating requests determining whether the accumulated task request has reached the determined batch size, and determining whether further accumulation of task requests would increase latency of any task request at risk of exceeding the given latency.

8. The computing system in accordance with claim 7, the computer-executable instructions being structured such that, when executed by the one or more processors, the computing system would be adapted to perform scheduling by:
if determining either that the accumulated task requests has reached the determined batch size, or that further accumulation of task requests would increase latency of any task request at risk of exceeding the given latency, submitting the accumulate task requests to the model combination.

9. The computing system in accordance with claim 8, the computer-executable instructions being structured such that, when executed by the one or more processors, the computing system would be adapted to perform scheduling by:
reordering the task requests to group according to groups based on input size.

10. The computing system in accordance with claim 1, the computer-executable instructions being structured such that, when executed by the one or more processors, the computing system would be adapted to:
reordering the task requests to group according to groups based on input size.

11. The computing system in accordance with claim 1, the compute level being expressed as a time that is sufficient for a given compute power to perform tasks of the given inference type.

12. The computing system in accordance with claim 1, the compute level being expressed as a compute power that is sufficient to perform tasks of the given inference type within a given time.

13. The computing system in accordance with claim 1, the plurality of combinations being restricted to be a maximum number of machine-learning models.

14. The computing system in accordance with claim 13, the maximum number of machine-learning models being four.

15. The computing system in accordance with claim 13, the maximum number of machine-learning models being three.

16. The computing system in accordance with claim 1, the computer-executable instructions being structured such that, when executed by the one or more processors, the computing system would be adapted to do the following for each at least some of the plurality of machine-learning model combinations:
for each of a plurality of aggregation methods for the machine-learning model combination, estimate an accuracy of the machine-learning model combination in performing tasks of the given inference task type with the aggregation method,
the selection of the machine-learning model combination for the given inference task type also selecting the aggregation method for the machine-learning model combination.

17. The computing system in accordance with claim 1, the accuracy of the machine-learning model combination in performing tasks of the given inference task type comprising splitting input data into a first subset of input data and a second set of input data, the accuracy of the model combination being measured by a conformity between the output of the model combination when provided with the first subset of the input data and the output of the machine-learning model combination when provided with the second subject of the input data.

18. A method for configuring compute resources to perform tasks of a given inference task type by:
for each of a plurality of machine-learning model combinations, estimating 1) a compute level that is structured to perform tasks of the given inference type using the machine-learning model combination, and 2) an accuracy of the machine-learning model combination in performing tasks of the given inference task type, the accuracy obtained by comparing against a ground truth or a result of a randomly seeded split;
selecting a machine-learning model combination for the given inference task type according to at least one of 1) the estimated compute level of the model combination and 2) the estimated accuracy of the model combination; and
in response to the selection, configuring an inference component to respond to task requests of the given inference task type by using the selected model combination such that the inference components responds to task requests of the given inference type using the selected model combination.

19. The method in accordance claim 18, further comprising:
responding to receiving a plurality of task requests to perform tasks of the given inference type by scheduling the plurality of task requests with each machine-learning model of the selected machine-learning model combination, the scheduling being performed by:
accumulating task requests, and while accumulating requests determining whether the accumulated task requests have reached the determined batch size, and determining whether further accumulation of task requests would increase latency of any task request at risk of exceeding the given latency; and
if determining either that the accumulated task requests has reached the determined batch size, or that further accumulation of task requests would increase latency of any task request at risk of exceeding the given latency, submitting the accumulate task requests to the model combination.

20. A computer program product comprising one or more computer-readable storage media having stored thereon computer-executable instructions that are structured such that, when executed by one or more processors of a computing system, the computing system would be configured to perform a method for configuring compute resources to perform tasks of a given inference task type by:
for each of a plurality of machine-learning model combinations, estimating 1) a compute level that can perform tasks of the given inference type using the machine-learning model combination, and 2) an accuracy of the machine-learning model combination in performing tasks of the given inference task type, the accuracy obtained by comparing against a ground truth or a result of a randomly seeded split;
selecting a machine-learning model combination for the given inference task type according to the estimated compute level of the model combination and the estimated accuracy of the model combination; and
in response to the selection, configuring an inference component to respond to task requests of the given inference task type by using the selected model combination such that the inference components responds to task requests of the given inference type using the selected model combination.
